(19) United States
(12) Patent Application Publication
(10) Pub. No.: US 2025/0014850 A1
(43) Pub. Date: Jan. 9, 2025

(54) QUENCHING CHAMBER FOR TWO-WAY DC CURRENT

(71) Applicant: SAFRAN ELECTRICAL & POWER, Blagnac (FR)

(72) Inventors: Kévin ENOUF, MOISSY-CRAMAYEL (FR); Guillaume PRIEUR, MOISSY-CRAMAYEL (FR); Alexis SCHACH, MOISSY-CRAMAYEL (FR); Cecil BELTAN, MOISSY-CRAMAYEL (FR)

(73) Assignee: SAFRAN ELECTRICAL & POWER, Blagnac (FR)

(21) Appl. No.: 18/711,266

(22) PCT Filed: Nov. 16, 2022
(86) PCT No.: PCT/FR2022/052104

§ 371 Date: May 17, 2024

(30) Foreign Application Priority Data
Nov. 22, 2021 (FR) 2112342

(51) Int. Cl. H01H 33/18; B64D 47/00

(52) U.S. Cl. CPC H01H 33/18; B64D 47/00

(57) ABSTRACT

A quenching chamber includes, for each zone of contact between a mobile contact and two fixed contacts, respectively, two pairs of guides that extend from the mobile contact and the contact zone in question, respectively, so as to guide, under the action of a magnetic field of constant direction, an electric arc. The pairs of guides follow one after the other in the direction of the magnetic field, and each pair of guides delineates between them a guiding zone. The guiding zones overlap at least partially in the direction of the magnetic field.

### TECHNICAL FIELD OF THE INVENTION

This invention relates to a quenching chamber, a quenching system and an aircraft.

The invention applies in particular to high voltages, for example 800V and above, such as may be present on board an aircraft.

### Technological Background

A quenching chamber for a two-way DC current generally comprises:
first and second fixed contacts;
a mobile contact designed to move between: a closed position in which the mobile contact is in contact with the fixed contacts, at first and second contact zones respectively, and an open position in which the mobile contact is away from the fixed contacts.

This type of quenching chamber is known as a double quenching chamber because the mobile contact separates from two fixed contacts.

When the quenching chamber is opened, an electric arc occurs between the mobile contact and each contact zone. If left in place, these electric arcs could damage the contacts over time.

The magnetic blowing is a known technique for moving the electric arc away from the contacts, in particular to be led to a dispersion unit of the electric arc. This technique involves using a magnetic field so that the Laplace force moves the electric arc.

The Laplace force is given by: \vec{dF}=I·\vec{dl}·\hat{ }\vec{B} with \vec{F} the force applied to the electric arc, I the current of the electric arc, \vec{l} the element through which the electric arc passes, \vec{B} the magnetic field to which the electric arc is subjected.

It may be desirable to reduce the compactness of the contactor.

The US patent application published under number US 2014/166620 A1 describes a double quenching chamber. The US patent application US 2014/360982 A1 and Japanese patent application JP 2016 004622 A each describe a single quenching chamber.

### SUMMARY OF THE INVENTION

A quenching chamber for two-way DC current is therefore proposed, characterised in that it comprises:
first and second fixed contacts;
a mobile contact designed to move between:
   a closed position in which the mobile contact is in contact with the fixed contacts, at first and second contact zones respectively, and
   an open position in which the mobile contact is moved away from the fixed contacts;
a device for generating a magnetic field having a constant direction;
for each contact zone: a first, respectively second, pair of guides extending from the mobile contact and the contact zone under consideration, for guiding, under the action of the magnetic field, an electric arc of current flowing in one orientation, respectively in the other orientation, between the contact zone under consideration and the mobile contact;
   wherein the pairs of guides succeed one another in the direction of the magnetic field and, with each pair of guides delimiting a guide zone between them, the guide zones overlap at least partially in the direction of the magnetic field, wherein the mobile contact is designed to move along a direction of movement between the open position and the closed position, and wherein the dispersion units lie on the same side of a plane passing through the contact zones and defined by the direction of the magnetic field and the direction of movement of the mobile contact.

The invention allows to reduce the size of the generation device of the magnetic field by overlapping the guide zones. Thus, the compactness of the quenching chamber is improved. In addition, when two such quenching chambers are associated, it is possible to place the dispersion units of one opposite the dispersion units of the other, in order to leave a central space between the two quenching chambers allowing ionisation gases to be easily evacuated outwards.

Optionally, each of the guides can belong to only one of the pairs.

Also optionally, the guides are fixed and the guides extending from the mobile contact are separated therefrom by a gap allowing movement of the mobile contact.

Also optionally, the two contact zones succeed one another in the direction of the magnetic field.

Also optionally, the contactor further comprises, for each contact zone, first and second electric arc dispersion units, up to which the first and second pairs of guides extend, respectively.

Also optionally, the dispersion units also comprise fin blocks.

A quenching system is also proposed, comprising two quenching chambers according to the invention, wherein the two planes delimit between them a central space outside which the dispersion units are located.

An aircraft comprising a quenching chamber according to the invention is also proposed.

An aircraft comprising a quenching system according to the invention is also proposed.

### BRIEF DESCRIPTION OF THE FIGURES

The invention will be better understood with the aid of the following description, given only by way of example and made with reference to the attached drawings in which:

FIG. 1 is a three-dimensional view of an example of a quenching chamber according to the invention,

FIG. 2 is a three-dimensional view of contacts in the quenching chamber shown in FIG. 1,

FIG. 3 is a top view of the quenching chamber in FIG. 1,

FIG. 4 is a side view of the quenching chamber in FIG. 1,

FIG. 5 is a view of the other side of the quenching chamber in FIG. 1,

FIG. 6 is a side view with the first and second pairs of guides superimposed, to see how they overlap, and

FIG. 7 is a top view of a quenching system according to the invention.

### DETAILED DESCRIPTION OF THE INVENTION

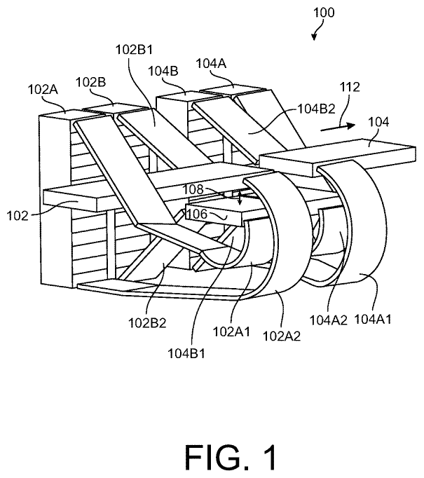

With reference to FIG. 1, an example of a quenching chamber 100 according to the invention will now be described. In the following description, the terms “fixed” and “mobile” are used in relation to each other.

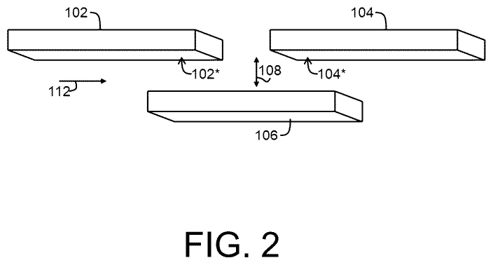

The quenching chamber 100 is for DC current and two-way. It comprises two fixed contacts 102, 104 and a mobile contact 106. The latter is designed to move, relative to the fixed contacts 102, 104, in a direction of movement 108 between two positions. The first of these two positions is a closed position in which the mobile contact 106 is in contact with the fixed contacts 102, 104, respectively in two contact zones (visible in FIG. 2 and bearing the references 102* and 104* respectively).

The second of these two positions is an open position in which the mobile contact 106 is away from the fixed contacts 102, 104 (as shown in FIG. 1).

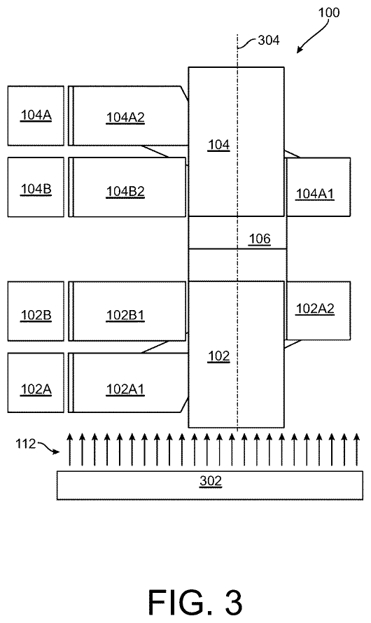

The quenching chamber 100 also comprises a device (visible in FIG. 3 and bearing reference 302) for generating a magnetic field 112. The magnetic field 112 has a constant direction and preferably a constant amplitude. The generation device 302 comprises a permanent magnet, for example.

The generating device 302 is for example arranged so that the two contact zones 102*, 104* succeed one another in the direction of the magnetic field 112, for example so that they are aligned in the direction of the magnetic field 112.

For each contact zone 102*, 104*, the quenching chamber 100 also comprises two electric arc dispersion units 102A, 102B and 104A, 104B, such as two fin blocks. In particular, each fin block is designed to receive an electric arc and increase a voltage of the latter above a voltage applied between the two fixed contacts 102, 104 by a voltage source (not shown). To achieve this, the fins are designed to de-ionise the electric arc.

The dispersion units 102A, 102B, 104A, 104B are all on the same side of the quenching chamber 100, and more specifically on the same side of the contacts 102, 104, 106. This means, for example, that they are on the same side of a plane (visible in FIG. 3 and marked 304) passing through the contact zones 102*, 104* and defined by the direction of the magnetic field 112 and the direction 108 of movement of the mobile contact 106. Preferably, the dispersion units 102A, 102B, 104A, 104B succeed one another along the direction of the magnetic field 112. For example, they are aligned along the direction of the magnetic field 112.

The quenching chamber 100 also comprises, for each contact zone 102*, 104*, first and second pairs of runners, bearing the references 102A1, 102A2 and 102B1, 102B2 for the contact zone 102* and 104A1, 104A2 and 104B1, 104B2 for the contact zone 104*. A guide space is delimited by the two guides of each pair. This guide space is swept by the electric arc when its two roots (i.e. the two ends of the electric arc) follow the two guides respectively.

For the contact zone 102*, guides 102A1, 102A2 of the first pair extend from the mobile contact 106 and the contact zone 102* respectively to an electric arc entry face of the first dispersion unit 102A. The guides 102B1, 102B2 of the second pair extend from the contact zone 102* and the mobile contact 106 respectively to an electric arc entry face of the second dispersion unit 102B.

Similarly, for the contact zone 104*, the guides 104A1, 104A2 of the first pair extend from the contact zone 104* and the mobile contact 106 respectively to an electric arc entry face of the first dispersion unit 104A. The guides 104B1, 104B2 of the second pair extend from the mobile contact 106 and the contact zone 104* respectively and to an electric arc entry face of the second dispersion unit 104B.

For each contact zone 102*, 104*, one of the two pairs of guides remains on the side (relative to the plane 304) of the dispersion units, while the other of the two pairs of guides leaves on the other side, bypasses the fixed contact 102, 104 or the mobile contact 106 (as in the example shown) by crossing the plane 304, and then ends on the side (relative to the plane 304) of the dispersion units.

In addition, for each contact zone 102*, 104*, the two pairs of guides succeed one another, at least in part, in the direction of the magnetic field 112. For example, the four pairs of guides succeed one another at least in part along the direction of the magnetic field 112. In FIG. 3, the four pairs of guides succeed one another on the left of the plane 304 (i.e. on the side of dispersion units 102A, 102B, 104A, 104B).

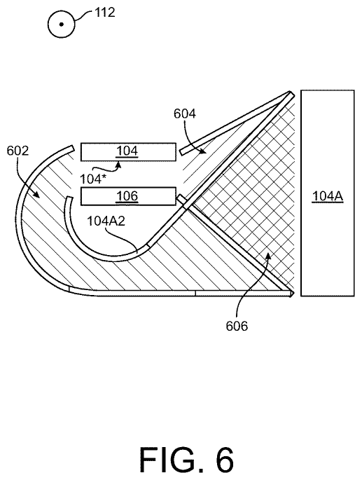

The guide spaces therefore overlap at least partially in the direction of the magnetic field 112. This overlap can be seen in FIG. 6, where the guide space 602 of one of the pairs of guides (102A1, 102A2 or 104B1, 104B2) is hatched in one orientation and the guide space 604 of the other pair of guides (102B1, 102B2 or 104A1, 104A2) is hatched in the other orientation. The overlap 606 corresponds to the hatched area in both orientations. Thanks to this overlap 606, the zone where the magnetic field 112 is to be generated is limited in the plane perpendicular to the magnetic field 112. This simplifies the generation device 302 and, in particular, reduces its size.

The guides are also fixed, for example. To enable the mobile contact to be moved, the guides extending from it are separated from the mobile contact by a gap, for example, through which the electric arc can easily pass. Alternatively, these guides could slide over the mobile contact as it moves.

An example of the function of the quenching chamber 100 will now be described.

When the quenching chamber 100 is opened, the mobile contact 106 separates from the fixed contacts 102, 104. An electric arc appears at each contact zone 102*, 104*.

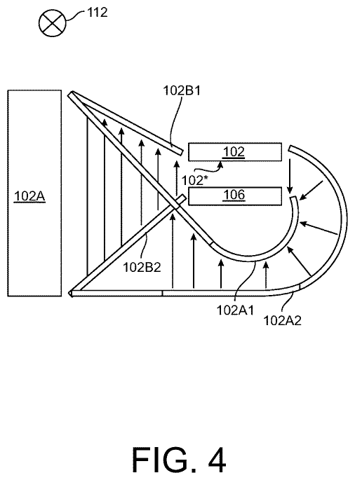

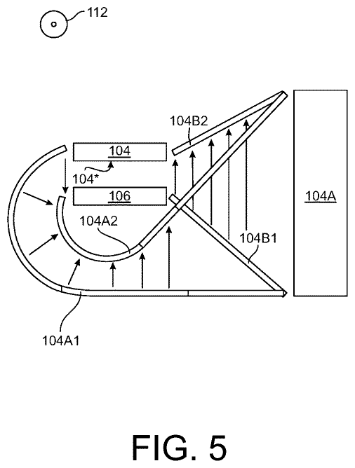

Due to the constant direction of the magnetic field 112, the electric arc is subject to the Laplace force and is therefore guided by one or other (FIG. 4 and FIG. 5) of the pairs of guides, depending on the direction of current flow (from the fixed contact 106 to the mobile contact 102, 104 or vice versa). The pair of guides used by the electric arc then guides the latter to the associated dispersion unit.

For example, if current enters the quenching chamber 100 via the fixed contact 102 and leaves via the fixed contact 104, the electric arc in the contact zone 102* is guided by the pair of guides 102A1, 102A2 to the dispersion unit 102A and the arc in the contact zone 104* is guided by the pair of guides 104B1, 104B2 to the dispersion unit 104B. If current enters the quenching chamber 100 via the fixed contact 104 and leaves via the fixed contact 102, the electric arc in the contact zone 102* is guided by the pair of guides 102B1, 102B2 to the dispersion unit 102B and the electric arc in the contact zone 104* is guided by the pair of guides 104A1, 104A2 to the dispersion unit 104A.

Preferably, the guides extend substantially perpendicular to the direction of the magnetic field 112, so that the Laplace force is maximised.

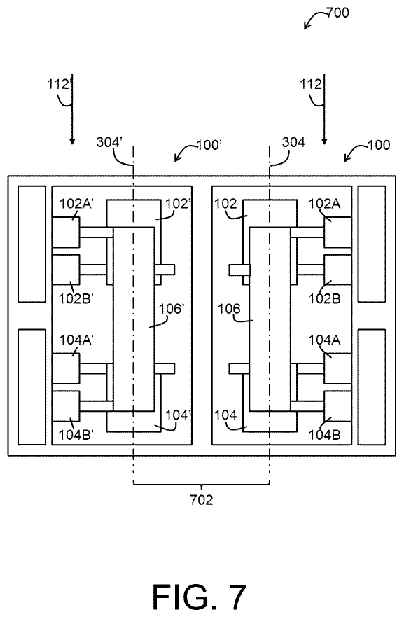

With reference to FIG. 7, an example of a double quenching system 702 according to the invention will now be described.

This quenching system 702 comprises two quenching chambers like the quenching chamber 100. The elements of these quenching chambers will be designated by the same references as in FIGS. 1 to 5, with the addition of a prime symbol “′” for one of them to distinguish them.

As can be seen in FIG. 6, the fact that the dispersion units in each quenching chamber 100, 100′ are on one side only is used to bring the quenching chambers 100, 100′ closer together. More specifically, the quenching chambers 100, 100′ are adjoined to each other on their side without a dispersion unit. In this way, the quenching chambers 100, 100′ are arranged so that the planes 304, 304′ are opposite each other (for example, parallel to each other), so as to delimit a central space 702 between them. The dispersion units are then located outside this central space 702.

The presence of this central zone 702 without the dispersion units means that the ionisation gases can be easily evacuated outwards of the quenching chamber. This evacuation would, for example, be much more difficult if dispersion units were provided in this central zone 702, due to the orientation of the opposing fin blocks.

In addition, the magnetic fields 112, 112′ of the two quenching chambers 100, 100′ are preferably in the same direction.

In conclusion, it is clear that a quenching chamber such as the one described above allows to gain in compactness.

It will be further noted that the invention is not limited to the embodiments described above. In fact, it will appear to the person skilled in the art that various modifications can be made to the above-described embodiments, in the light of the teaching just disclosed.

For example, the electric arc dispersion units 102A, 102B, 104A, 104B could be omitted. In this case, arc dispersion could be achieved simply by moving the guides of each pair away from each other. However, this would result in a larger quenching chamber than would be the case if the electric arc dispersion units such as fin blocks were used.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. A quenching chamber for two-way DC current, the quenching chamber comprising:
first and second fixed contacts;
a mobile contact configured to move between:
a closed position, in which the mobile contact is in contact with the fixed contacts at first and second contact zones, respectively, and
an open position, in which the mobile contact is moved away from the fixed contacts;
a device configured to generate a magnetic field having a constant direction; and
for each contact zone: a first, respectively second, pair of guides extending from the mobile contact and the contact zone under consideration, for guiding, under the action of the magnetic field, an electric arc of current flowing in one orientation, respectively in the other orientation, between the contact zone under consideration and the mobile contact;
wherein the pairs of guides succeed one another in the direction of the magnetic field and, with each pair of guides delimiting a guide zone between them, the guide zones overlap at least partially in the direction of the magnetic field, wherein the mobile contact is designed to move along a direction of movement between the open position and the closed position, and wherein the dispersion units lie on the same side of a plane passing through the contact zones and defined by the direction of the magnetic field and the direction of movement of the mobile contact.

2. The quenching chamber according to claim 1, wherein each of the guides belongs to only one of the pairs.

3. The quenching chamber according to claim 1, wherein the guides are fixed and wherein the guides extending from the mobile contact are separated therefrom by a gap allowing movement of the mobile contact.

4. The quenching chamber according to claim 1, wherein the two contact zones succeed one another in the direction of the magnetic field.

5. The quenching chamber according to claim 1, further comprising, for each contact zone, first and second electric arc dispersion units, up to which the first and second pairs of guides extend, respectively.

6. The quenching chamber according to claim 1, wherein the dispersion units comprise fin blocks.

7. A quenching system, comprising two quenching chambers according to claim 1, wherein the two planes delimit between them a central space outside which the dispersion units are located.

8. An aircraft comprising the quenching chamber according to claim 1.

9. An aircraft comprising a quenching system according to claim 7.
